(19) United States
(12) Patent Application Publication
(10) Pub. No.: US 2002/0167211 A1
(43) Pub. Date: Nov. 14, 2002

(54) Massage chair

(76) Inventor: Taka Hisa Nishi Yama, Taipei (TW)

Correspondence Address: ROSENBERG, KLEIN & LEE, 3458 ELLICOTT CENTER DRIVE,, SUITE 101, ELLICOTT CITY,, MD, 21043, US

(21) Appl. No.: 09/852,545

(22) Filed: May 8, 2001

(51) Int. Cl. B60N 2/02

(52) U.S. Cl. 297/378.1

(57) ABSTRACT

The present invention provides a massage chair, wherein the bottom of a supporting component is joined on a stage. A seat rack is fixed at the top of the supporting component. A back rack is disposed above the rear side of the seat rack. A connection component is joined at two sides of the back rack and the supporting component. The back rack can make a downward action. A fixing shaft is fixed on the connection component. A press portion and a locating claw are pivotally joined at the bottom of the back rack. The locating claw can be resiliently fastened on the fixing shaft to let the back rack be located when being erected. Through pressing the press portion to let the locating claw leave from the fixing shaft, the chair back portion composed of the back rack can make a forward down folding action.

### FIELD OF THE INVENTION

The present invention relates to a massage chair and, more particularly, to a massage chair capable of being folded to occupy less space and to facilitate transportation and storing up when being transported or not in use.

### BACKGROUND OF THE INVENTION

Progress of society brings up modernized and mechanized civilization, making human lives much more comfortable and convenient. However, opportunities of human activities and exercises relatively decrease, resulting in sickly human bodies. Therefore, various kinds of massage equipments have been proposed.

As shown in FIG. 1, a prior art massage chair 10a is a chair with a proper massage set (e.g., a massage set for kneading or patting, which is not shown) disposed on a chair back portion 11a thereof to generate massaging effect for the human body portion, e.g., waist, back, or neck, contacting with the chair back portion 11a.

However, the chair back portion of a prior art massage chair cannot be folded forwards down. Therefore, the massage chair will occupy much space when being transported or not in use so that it is not convenient to transport or store up the massage chair.

Accordingly, the prior art massage chair has inconvenience and drawbacks in practical use. The present invention aims to solve the above problems.

### SUMMARY OF THE INVENTION

The primary object of the present invention is to provide a massage chair, whose chair back portion made of a back rack can be folded forwards down to occupy less space and to facilitate transportation and storing up when being transported or not in use.

To achieve the above object, the present invention provides a massage chair comprising a stage, a supporting component, a seat rack, a back rack, a connection component, a fixing shaft, an air pressure cylinder, a press portion, and a locating claw. The bottom of the supporting component is joined on the stage. The seat rack is fixed at the top of the supporting component. The back rack is disposed above the rear side of the seat rack. The connection component is joined at two sides of the back rack and two sides of the supporting component so that the seat rack and the back rack can be joined together through the connection component. The back rack can make a downward action.

The fixing shaft is fixed on the connection component. One end of the air pressure cylinder is joined with the supporting component, and the other end thereof is joined with the fixing shaft. The press portion and the locating claw are joined together. The press portion and the locating claw are pivotally joined at the bottom of the back rack. The locating claw can be resiliently fastened on the fixing shaft. A massage chair is thus formed.

The various objects and advantages of the present invention will be more readily understood from the following detailed description when read in conjunction with the appended drawing, in which:

### BRIEF DESCRIPTION OF THE DRAWINGS

FIG. 1 is a perspective view of a prior art massage chair;

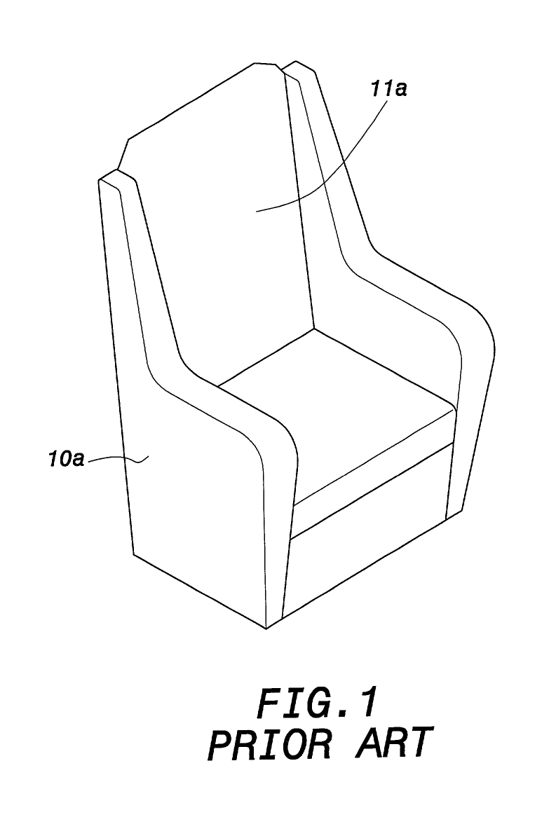

FIG. 2 is a side view of the present invention;

FIG. 3 is a side view showing the folded state of the chair back portion of the present invention;

FIG. 4 is a perspective view of the connection component of the present invention;

FIG. 5 is a side view of the locating device of the present invention;

FIG. 6 is a front view of the locating device of the present invention; and

FIG. 7 is a top view of the locating device of the present invention.

### DETAILED DESCRIPTION OF THE PREFERRED EMBODIMENTS

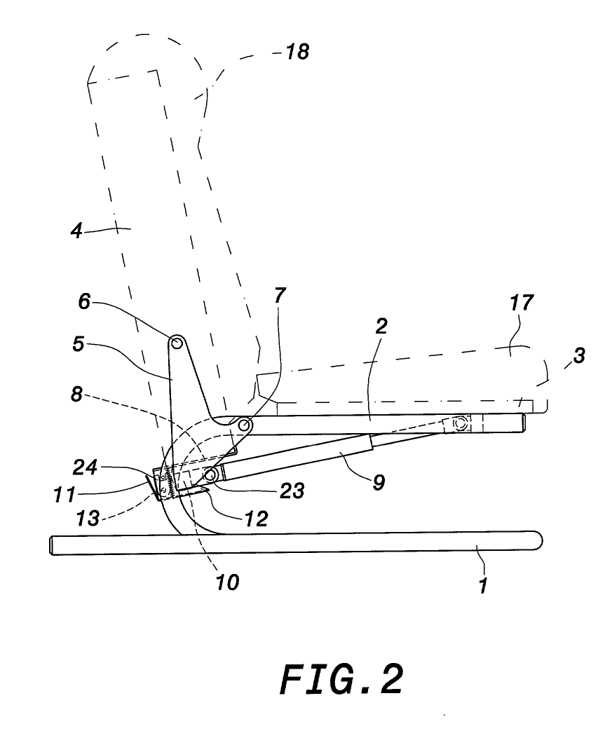

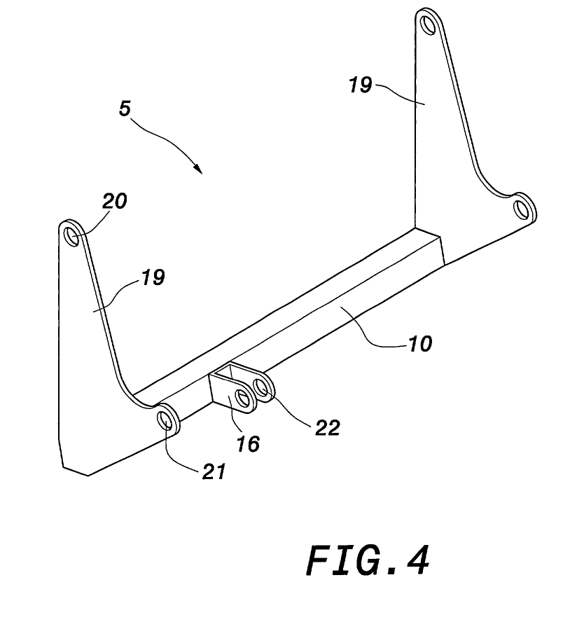

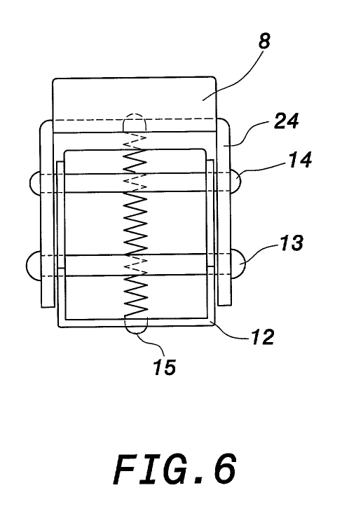

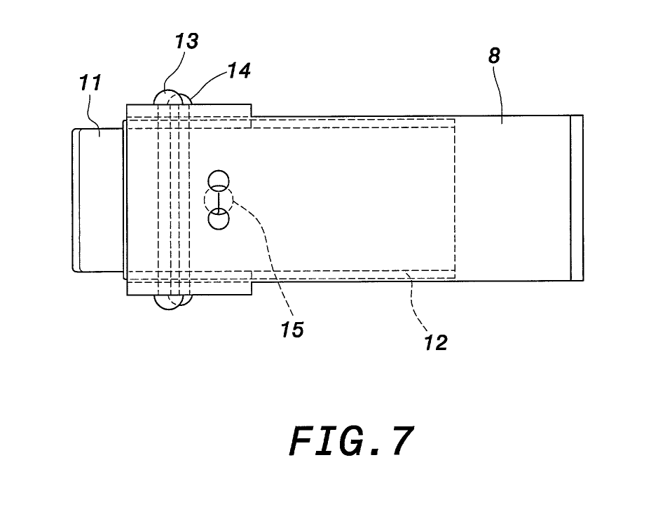

As shown in FIGS. 2 to 7, a massage chair of the present invention is a chair comprising a stage 1, a supporting component 2, a seat rack 3, a back rack 4, a connection component 5, two first supporting shafts 6, two second supporting shafts 7, a fixing component 8, an air pressure cylinder 9, a fixing shaft 10, a press portion 11, a locating claw 12, a third supporting shaft 13, a limiting shaft 14, a resilient part 16, and a connection portion 16.

The stage 1 is a firm architecture with an unrestricted shape. The stage 1 is disposed at the bottom of the massage chair. The stage 1 can be placed on the ground so that the massage chair can be firmly fixed on the ground.

The supporting component 2 forms a U-shaped architecture when viewed sideward. The supporting component 2 is disposed above the stage 1 with the bottom thereof joined on the stage 1 to let the stage 1 and the supporting component 2 be joined together. The supporting component 2 can support the seat rack 3 and the back rack 4 at predetermined heights.

The seat rack 3 is fixed at the top of the supporting component 2. The seat rack 3 can be supported at a predetermined height through the supporting component 2. The seat rack 3 can have a pad 17 made of soft material disposed thereon. The seat rack 3 and the pad 17 together form a chair seat portion.

The back rack 4 is disposed above the rear side of the seat rack 3. The back rack 4 can have a pad 18 made of soft material disposed thereon. The back rack 4 and the pad 18 together form a chair back portion.

The connection component 5 is composed of two V-shaped panels 19. The two panels 19 are oppositely disposed. Each of the two panels 19 has a first connection hole 20 and a second connection hole 21 thereon. The first connection holes 20 of the two panels 19 are joined at two sides of the back rack 4 through the two first supporting shafts 6 so that the connection component 5 can be joined at two sides of the back rack 4. The second connection holes 21 of the two panels 19 are joined at two sides of the supporting component 2 through the two second supporting shafts 7 so that the connection component 5 can be joined at two sides of the supporting component 2. Thereby, the seat rack 3 and the back rack 4 can be joined together through the connection component 5, and the back rack 4 can make a downward action with the first supporting shafts 6 as the fulcrum.

The fixing shaft 10 is fixed between the two panels 19 of the connection component 5. The connection portion 16 is fixed on the fixing shaft 10. The fixing shaft 10 has two third connection holes 22 thereon for connecting the air pressure cylinder 9.

One end of the air pressure cylinder 9 is joined at the top of the supporting component 2, and the other end thereof is joined at the third connection holes 22 of the fixing shaft 10 through a fourth supporting shaft 23 so that the other end of the air pressure cylinder 9 can be joined with the connection component 5. The air pressure cylinder 9 can thus be joined together with the back rack 4 through the connection component 5. Through the disposition of the air pressure cylinder, a buffering force can be provided when the back rack 4 makes a downward action.

The fixing component 8 is fixed at the bottom of the back rack 4. A pivotal seat 24 is fixed at the bottom of the fixing component 8. The press portion 11 and the locating claw 12 are joined together. The press portion 11 and the locating claw 12 also join a pivotal portion 25. The pivotal portion 25 is pivotally joined with the pivotal seat 24 at the bottom of the back rack 4 through the third supporting shaft 13. Thereby, the press portion 11 and the locating claw 12 can be pivotally joined at the bottom of the back rack 4 with the third supporting shaft 13 as the fulcrum. Moreover, the locating claw 12 is situated below the fixing shaft 10.

The limiting shaft 14 is fixed on the pivotal seat 24. The pivotal portion 25 has an indentation 26 disposed thereon. The limiting shaft 15 is situated inside the indentation 26. When the press portion 11 is pressed to jointly activate the locating claw 12, limiting function can be provided through the limiting shaft 14 shoring up the inner wall of the indentation 26.

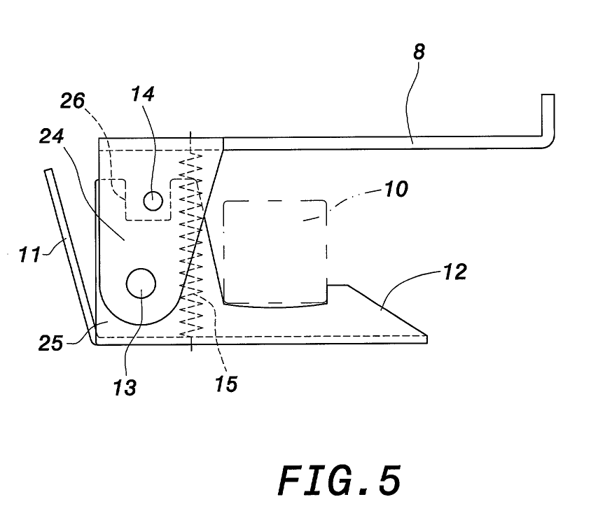

The resilient part 15 is an expansion spring. One end of the resilient part 15 is joined on the fixing component 8 at the bottom of the back rack 4, and the other end thereof is joined on the locating claw 12. The locating claw 12 can be resiliently fastened on the fixing shaft 10 (as shown in FIGS. 2 and 5) through the resilient part 15 pulling the locating claw 12 upwards, thereby forming a locating device. Therefore, the back rack 4 can be located when being erected. A massage chair of the present invention is thus formed.

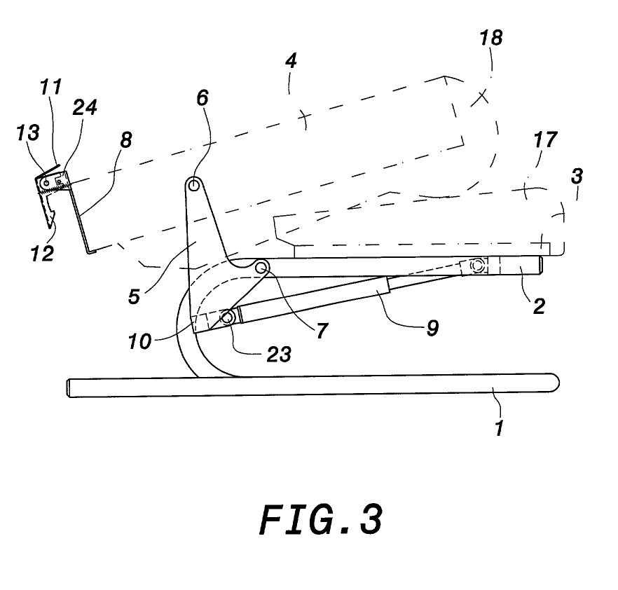

As shown in FIG. 3, the press portion 11 can be pressed to jointly activate the locating claw 12 to swing downwards so that the locating claw can leave from the fixing shaft 10. Thereby, the chair back portion composed of the back rack 4 and the pad 18 can make a forward down folding action so that the massage chair can be folded to occupy less space and to facilitate transportation and storing up when being transported or not in use.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A massage chair comprising:
a stage;
a supporting component with the bottom thereof joined on said stage;
a seat rack fixed at the top of said supporting component;
a back rack disposed above the rear side of said seat rack;
a connection component joined at two sides of said back rack and two sides of said supporting component whereby said seat rack and said back rack can be joined together and said back rack can make a downward action;
a fixing shaft fixed on said connection component;
an air pressure cylinder with one end thereof joined with said supporting component and the other end thereofjoined with said fixing shaft;
a press portion; and
a locating claw joined together with said press portion, said press portion and said locating claw being pivotally joined at the bottom of said back rack, said locating claw being resiliently fastened on said fixing shaft, said press portion being pressed to jointly activate said locating claw to leave from said locating shaft.

2. The massage chair as claimed in claim 1, wherein said seat rack has a pad disposed thereon, and said seat rack and said pad together form a chair seat portion.

3. The massage chair as claimed in claim 1, wherein said back rack has a pad disposed thereon, and said back rack and said pad together form a chair back portion.

4. The massage chair as claimed in claim 1, wherein a fixing component is fixed at the bottom of said back rack, a pivotal seat being fixed at the bottom of said fixing component, said press portion and said locating claw joining a pivotal portion, said pivotal portion being pivotally joined with said pivotal seat at the bottom of said back rack through a third supporting shaft so that said press portion and said locating claw are pivotally joined at the bottom of said back rack with said third supporting shaft as the fulcrum.

5. The massage chair as claimed in claim 4, wherein a limiting shaft is fixed on said pivotal seat, said pivotal portion has an indentation thereon, and said limiting shaft is situated inside said indentation.

6. The massage chair as claimed in claim 1, wherein a resilient part is joined between the bottom of said back rack and said locating claw to pull said locating claw so that said locating claw can be resiliently fastened on said fixing shaft.

7. The massage chair as claimed in claim 1, wherein said connection component is composed of two panels, each said panel having a first connection hole and a second connection hole, said first connection holes of said two panels being joined at two sides of said back rack through two first supporting shafts so that said connection component is joined at two sides of said back rack, said second connection holes of said two panels being joined at two sides of said supporting component through two second supporting shafts so that said connection component is joined at two sides of said supporting component.

8. The massage chair as claimed in claim 1, wherein said fixing shaft has a connection portion disposed thereon, said connection portion having a third connection hole thereon, the other end of said air pressure cylinder being joined with said third connection hole of said fixing shaft through a fourth supporting shaft.
